(19) United States
(12) Patent Application Publication
(10) Pub. No.: US 2009/0235829 A1
(43) Pub. Date: Sep. 24, 2009

(54) ANTI-ADHERENT GRATE FOR GRILLING FOOD

(76) Inventor: Joao Baptista VAZ, Vila Nova de Gaia (PT)

Correspondence Address: GOTTLIEB RACKMAN & REISMAN PC, 270 MADISON AVENUE, 8TH FLOOR, NEW YORK, NY, 10016-0601, US

(21) Appl. No.: 12/052,075

(22) Filed: Mar. 20, 2008

(51) Int. Cl. A47J 37/07; B23P 11/00

(52) U.S. Cl. 99/450; 126/152 R

(57) ABSTRACT

An improved grilling surface is disclosed which employs pointed tips to decrease the surface area of the grill surface in contact with the food being grilled. Long members are crossed in a manner similar to how a conventional grill surface is constructed, but then additional members that point towards the food are added in an evenly spaced grid pattern. The food rests on the points of these members.

### FIELD OF THE INVENTION

The present invention relates to cooking surfaces. More precisely, the present invention relates to a permeated surface for holding food a distance away from a flame.

### BACKGROUND OF THE INVENTION

Various apparatus and methods of holding food a distance away from a flame are well known in the art. Permeated surfaced that can be fixed above a flame are also well known in the art. The most common and basic example is that of a backyard barbeque grill. The grill can be constructed in many different patterns, though the easiest to manufacture is that of crossing strips of a material in a grid-like pattern.

Most often these grills are constructed of a metal such as iron or aluminum, but they can be of any material that can withstand high temperatures without melting.

The thickness and spacing of the grill can vary widely, depending on the intended use of the grill. A permanent outdoor grill may have to be of a thick rust resistant metal, where a grill for cooking small vegetables may be made thin with small gaps to prevent smaller vegetables from falling through it.

Grills in general have several benefits. First they keep food a distance away from the flame while being cooked. By keeping the food a distance away from the flame, the amount of ash or other residue that comes in contact with the food is minimized. Further, the distance decreases the heat transferred by the flame and lessens the chance of burning the food.

All the benefits of the conventional grill aside, there are major drawbacks that the present invention solves. It is very common for food being grilled to become stuck to the grill surface. This is a major inconvenience, first because when the food is removed from the grill it may become torn apart. And second, the food that is stuck to the grill is very difficult to remove because of the grill's high temperature.

In addition to being difficult to remove food, grill surfaces often go without cleaning. Food from a prior use that fails to be properly removed from the grill can, over time, lead to a build up of bacteria. And even if the food is properly removed, dirt or bacteria can still build on the grill surface because of its exposure to the outdoor elements.

### SUMMARY OF THE INVENTION

To solve the above mentioned limitations of conventional grilling surfaces, the present invention employs a grill wherein food rests on pointed tips instead of long crossing members. The pointed tips are created by having U-shaped members attach to long crossing members. The long crossing members form the body of the grill and hold the pointed tips in place. The present invention also involves a handle, which is constructed as part of the long crossing member body.

The use of pointed tips in the present invention decreases the surface area of the grill that comes into contact with the food being cooked. This thereby decreases the likelihood of the food being stuck to the grill surface and at the same time reduces the transfer of dirt and bacteria from the grill surface to the food.

### BRIEF DESCRIPTION OF THE FIGURES

To further satisfy the recited objectives, a detailed description of typical embodiments of the invention is provided with reference to appended drawings that are not intended to limit the scope of the invention, in which:

FIG. 1 is a front perspective view of the preferred embodiment of the present invention.

FIG. 2 is a close-up of a front perspective view of the preferred embodiment of the present invention.

FIG. 3 is another close-up of a front perspective view of the preferred embodiment of the present invention.

### DESCRIPTION OF THE INVENTION

To solve the before mentioned drawbacks to conventional grills, the present invention employs a grill surface constructed of vertical pillars, where the food makes contact with the pillar tip, as opposed to the far greater surface area of a conventional grill.

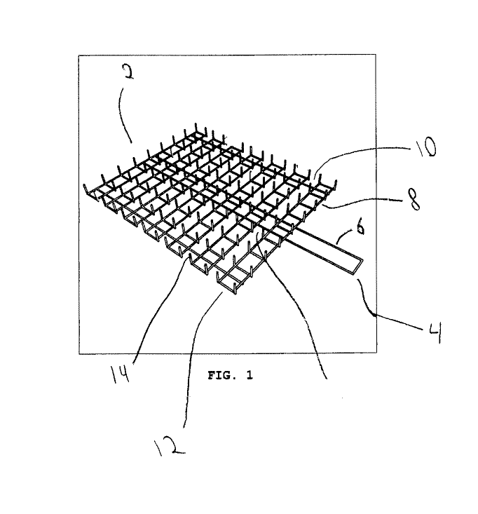

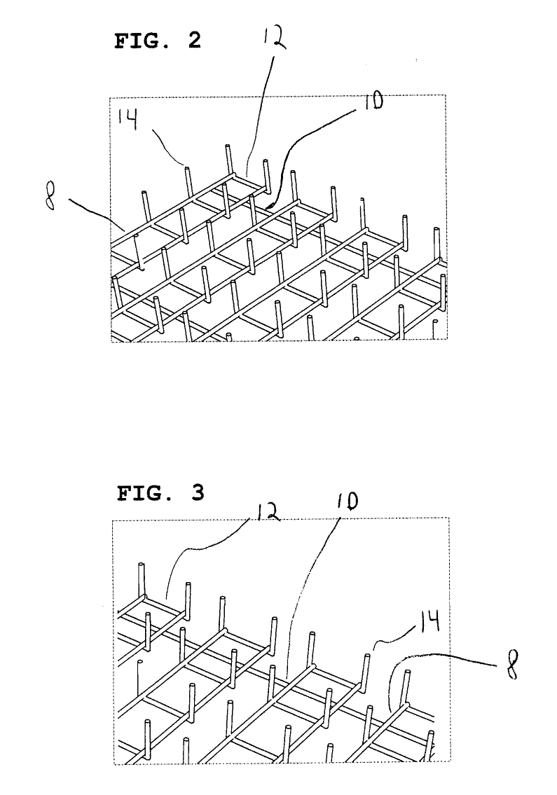

As shown in FIG. 1, the present invention is constructed of long thin strips of a preferably metal material. The main grilling surface 2 is preferably of a rectangular shape with a handle 4 extending from the rectangular surface 2.

A central member 6 is bent at a right angle in two places and forms both the handle 4 and the center of the grilling surface 2. Side members 8 are disposed perpendicular the central member 6. The structural integrity of the grill is also ensured by supporting members 10. There are preferably two of these members and they run parallel to the central member 6 and perpendicular to the side members 8.

The combination of the before mentioned elements 2-10 are known in the art. It is the addition of multiple U-shaped members 12 with their points 14 all facing in the same direction that create the present invention.

The U-shaped members 12 are attached to two side members. The attachment occurs at the two bends in the U-shaped member and is preferably done by soldering.

The distance between U-shaped members 12 should be the spaced along the side member 8 from each other by approximately the same distance. This distance is preferably the same as the distance between points 14 of the same U-shaped member. This distance may be in the range of 15 mm to 25 mm. This creates a grill where the points 14 are evenly spaced from each other in a grid type pattern.

The height of each point should be relatively low. Greater heights require more material and decrease the stability of the overall structure. That being said, there is no advantage to keeping the food more than a nominal distance from side members 8 and supporting members 10. A typical height may be 20 mm to 30 mm.

The points 14 must be strong enough to support the weight of the food and keep it a distance from the flame. But when food is rested on these points, significantly less surface area comes into contact with the food than compared to a conventional grill surface.

The fact that there is less surface area means that there is less area for the food to stick to and less area for dirt or bacteria to contact the food at. Therefore the present invention makes grilling easier and safer.

The points 14 can be constructed in several different manners, each having its own purpose. A pointed tip or cone has the least surface area that would theoretically come in contact with the food, but such a small tip may pierce the surface of the food. The type of tip is best for grilling foods with a strong surface that will not pierce easily. But for foods with delicate surfaces, a cone tip is problematic for two reasons. First it may pierce the surface which may be visually or otherwise unappealing. And second, if the tip pierces the surface, the tip will enter the inside of the food. This will cause more surface area of the grill plate to come into contact with the food, reducing the before mentioned benefits.

The tip can also be constructed such that it is substantially flat. This tip has more surface area directly facing the food than compared to the cone tip described above. But the advantage of this tip is that the increased facing surface area lessens the likelihood of the tip piercing the surface of the food.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

What is claimed is:

1. An apparatus for grilling food comprising:
a body of crossing members; and
wherein said body of crossing members is a permeated surface predominantly made-up of openings.
a grid of points extending upwardly of said body sized and spaced to receive a food item for grilling.

2. The apparatus for grilling food set forth in claim 1, further comprising a handle connected to said body of crossing members.

3. The apparatus for grilling food set forth in claim 1, wherein said points are evenly spaced from each other.

4. The apparatus for grilling food set forth in claim 3, further comprising a handle connected to said body for crossing members.

5. The apparatus for grilling food set forth in claim 4, wherein said apparatus is constructed of metal.

6. The apparatus for grilling food set forth in claim 5, wherein said points are formed by soldering U-shaped members to said crossing members.

7. An apparatus for grilling food comprising:
a plurality of parallel vertical members;
wherein all of said parallel vertical members have a point on their upper side;
a body of horizontal crossing members;
wherein said vertical members are attached to said body of crossing members.

8. An apparatus for grilling food comprising:
three sets of crossing members;
wherein each set is perpendicular to both other sets;
wherein two of the sets contain members substantially longer than the members of the third set;
wherein the members of the third set are evenly spaced from one another.

9. The apparatus of claim 8, further comprising a handle constructed using members of both or either of the first two sets.
